(19) United States
(12) Patent Application Publication
(10) Pub. No.: US 2024/0281116 A1
(43) Pub. Date: Aug. 22, 2024

(54) INTERACTION METHOD AND APPARATUS, DEVICE, COMPUTER-READABLE STORAGE MEDIUM AND PRODUCT

(71) Applicant: Beijing Zitiao Network Technology Co., Ltd., Haidian District, Beijing (CN)

(72) Inventors: Shuyu Chen, Beijing (CN); Weiyi Chang, Beijing (CN); Ziyang Zheng, Beijing (CN)

(21) Appl. No.: 18/571,071

(22) PCT Filed: Sep. 23, 2022
(86) PCT No.: PCT/CN2022/121059

§ 371 Date: Dec. 15, 2023

(30) Foreign Application Priority Data
Sep. 30, 2021 (CN) 202111162299.7

(51) Int. Cl. G06F 3/0482

(52) U.S. Cl. CPC G06F 3/0482

(57) ABSTRACT

Provided are an interaction method and apparatus, a device, a computer-readable storage medium and a product. The method includes: displaying, within a preset display area on a media content playing interface, an interaction identifier associated with an online state of a first user associated with currently played media content; and presenting, in response to a triggering for the interaction identifier associated with the online state, an interface for carrying out interaction with the first user, which is associated with the online state.

### CROSS-REFERENCE TO RELATED APPLICATION(S)

This disclosure claims priority to Chinese Patent Application No. 202111162299.7, filed on Sep. 30, 2021 and entitled “Interaction method and apparatus, device, computer-readable storage medium and product”, the content of which is incorporated in its entirety herein by reference.

### FIELD

Embodiments of this disclosure relate to the technical field of network communication, and particularly relate to an interaction method and apparatus, a device, a computer-readable storage medium, a program product and a program.

### BACKGROUND

Software playing media content, such as video software, has gradually emerged in users' lives and entertain them in spare time. The users may record their lives by shooting and posting videos via the short video software. Moreover, the users can socialize with friends via the video software by making voice calls and video calls, sending direct messages, etc.

### SUMMARY

Embodiments of this disclosure provide an interaction method and apparatus, a device, a computer-readable storage medium, a program product and a program.

In a first aspect, an embodiment of this disclosure provides an interaction method. The interaction method is applied at a second user side and includes displaying, within a preset display area on a media content playing interface, an interaction identifier associated with an online state of a first user associated with currently played media content; and presenting, in response to a triggering for the interaction identifier associated with the online state, an interface for carrying out interaction with the first user, which is associated with the online state.

In a second aspect, an embodiment of this disclosure provides an interaction apparatus. The interaction apparatus includes: a display module, configured to display, within a preset display area on a media content playing interface, an interaction identifier associated with an online state of a first user associated with currently played media content; and an interaction module, configured to present, in response to a triggering for the interaction identifier associated with the online state, an interface for carrying out interaction with the first user, which is associated with the online state.

In a third aspect, an embodiment of this disclosure provides an electronic device. The electronic device includes a processor and a memory; the memory storing computer-executable instructions; and the processor, when executing the computer-executable instructions stored in the memory, configured to perform the interaction method described in the first aspect and all possible designs of the first aspect.

In a fourth aspect, an embodiment of this disclosure provides a computer-readable storage medium, storing computer-executable instructions, a processor, when executing the computer-executable instructions, configured to implement the interaction method described in the first aspect and all possible designs of the first aspect.

In a fifth aspect, an embodiment of this disclosure provides a computer program product. The computer program product includes a computer program, where the computer program, when executed by a processor, implements the interaction method described in the first aspect and all possible designs of the first aspect.

In a sixth aspect, an embodiment of this disclosure provides a computer program. The computer program, when executed by a processor implements the interaction method described in the first aspect and all possible designs of the first aspect.

### BRIEF DESCRIPTION OF THE DRAWINGS

In order to describe technical solutions in embodiments of this disclosure or in the prior art more clearly, accompanying drawings required to be used in the description of the embodiments or the prior art will be briefly introduced below. Apparently, the accompanying drawings in the following description show some embodiments of this disclosure, and those of ordinary skill in the art would also be able to derive other accompanying drawings from these accompanying drawings without making creative efforts.

FIG. 1 is a schematic flow diagram of an interaction method according to Embodiment 1 of this disclosure;

FIG. 2 is a schematic diagram of an interaction interface according to an embodiment of this disclosure;

FIG. 3 is a schematic diagram of a display interface according to an embodiment of this disclosure;

FIG. 4 is a schematic diagram of another display interface according to an embodiment of this disclosure;

FIG. 5 is a schematic flow diagram of an interaction method according to Embodiment 2 of this disclosure;

FIG. 6 is a schematic diagram of an interaction interface according to an embodiment of this disclosure;

FIG. 7 is a schematic diagram of another interaction interface according to an embodiment of this disclosure;

FIG. 8 is a schematic diagram of yet another interaction interface according to an embodiment of this disclosure;

FIG. 9 is a schematic flow diagram of an interaction method according to Embodiment 3 of this disclosure;

FIG. 10 is a schematic diagram of still another interaction interface according to an embodiment of this disclosure;

FIG. 11 is a schematic structural diagram of an interaction apparatus according to Embodiment 4 of this disclosure; and

FIG. 12 is a schematic structural diagram of an electronic device according to Embodiment 5 of this disclosure.

### DETAILED DESCRIPTION OF EMBODIMENTS

In order to make the objective, technical solutions and advantages of embodiments of this disclosure more obvious, the technical solutions in the embodiments of this disclosure will be clearly and completely described below in combination with accompanying drawings in the embodiments of this disclosure. Apparently, the described embodiments are some embodiments, rather than all embodiments of this disclosure. On the basis of embodiments of this disclosure, all other embodiments derived by those of ordinary skill in the art without making creative efforts fall within the scope of protection of this disclosure.

In the related art, the function of watching media content and the function of socializing with friends in real time of current media playing software are independent from each other and cannot be associated excellently. Moreover, an existing interaction method is complicated to operate and will interrupt and affect video consumption of both users. This disclosure provides an interaction method and apparatus, a device, a computer-readable storage medium, a program product and a program, so as to solve the technical problem that an existing solution cannot achieve flexible and convenient communication with friends.

Existing application software generally provides an in-application interaction function. According to existing solutions, in order to implement the interaction function, it is generally required to click on a user profile photo to enter a user home interface or a chat interface, and trigger a preset interaction icon to carry out an interaction. However, the above methods are generally cumbersome, and it is required to skip to other interfaces to implement an interaction, which affects the interaction efficiency.

In order to further enhance an interaction intention of users on the basis of simplifying an interaction, an interaction identifier associated with an online state of a first user associated with currently played media content may be displayed on a media content playing interface such that a second user may rapidly implement an interaction with the first user in real time by triggering the interaction identifier.

It should be noted that the interaction method and apparatus, the device, the computer-readable storage medium, the program product and the program provided in this disclosure can be applied to interaction scenarios in various applications.

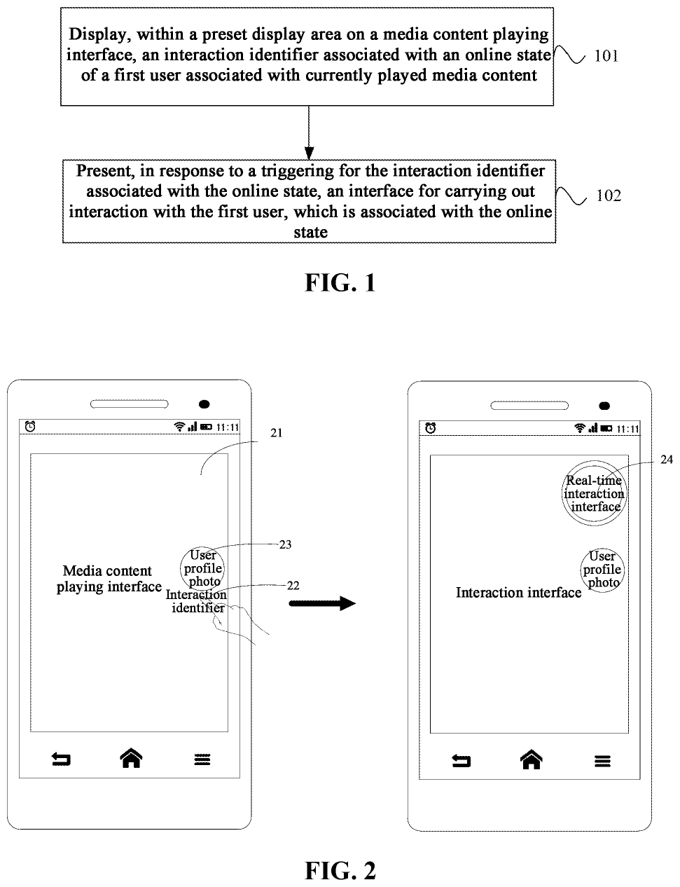

FIG. 1 is a schematic flow diagram of an interaction method according to Embodiment 1 of this disclosure. As shown in FIG. 1, the method includes the following:

Step 101: An interaction identifier associated with an online state of a first user associated with currently played media content is displayed within a preset display area on a media content playing interface .

In this embodiment, an executive body is an interaction apparatus, the interaction apparatus may be coupled to a terminal device of a second user, and the terminal device of the second user may carry out an information interaction with a terminal device of a first user. An interaction is carried out with the first user according to a triggering by the second user.

Alternatively, the interaction terminal may be further coupled to a server, and the server may be in communication connection to the terminal devices of the first user and the second user. An interaction is carried out with the first user according to a triggering by the second user on the terminal device.

In this embodiment, when the user browses media content, a media content stream may be played on a playing interface. In order to implement a rapid interaction, an interaction identifier associated with an online state of a first user associated with currently played media content may be displayed within a preset display area on a media content playing interface. The online state of the first user includes a first state and a second state. The first state represents that the first user is currently online or the first user is online in a preset time period. The second state may represent that the first user is offline currently and in a preset time period. Different online states may correspond to different interaction identifiers. For instance, in a case that the first user is online at any time within one hour, an interaction identifier corresponding to the first state may be displayed. It can be understood that the interaction identifier is displayed in a case that the user configures the online state to be visible, that is, when authorization from the user is obtained.

The interaction identifier may be displayed on a lower side of a user profile photo of the first user, or may be displayed in any preset display area on the media content playing interface, which is not limited by this disclosure.

Alternatively, the first user associated with the currently played media content is a poster of the currently played media content.

Step 102: In response to a triggering for the interaction identifier associated with the online state, an interface for carrying out interaction with the first user, which is associated with the online state, is presented.

In the embodiment, the second user may trigger the interaction identifier according to actual requirements after the interaction identifier is presented. The triggering may be any triggering mode such as single click, double click and long press, which is not limited by this disclosure.

Accordingly, an interaction with the first user may be carried out in response to a triggering by the second user for the interaction identifier associated with the online state, and an interface for carrying out interaction with the first user, which is associated with the online state, is displayed on a display interface.

Alternatively, the interface for the interaction may be displayed on the media content playing interface, or may skip to a specific detail interface to be displayed.

FIG. 2 is a schematic diagram of an interaction interface according to an embodiment of this disclosure. As shown in FIG. 2, an interaction identifier 22 associated with an online state of a first user may be displayed in a preset display area on a media content playing interface 21, and the interaction identifier 22 may be displayed on a lower side of a user profile photo 23 of the first user. The second user may trigger the interaction identifier 22, and an interface 24 for carrying out interaction with the first user, which is associated with the online state, may be displayed on a display interface in response to the triggering.

Alternatively, the first user satisfies a preset relation with a second user.

In this embodiment, since the first user and the second user may interact with each other, there may be a preset relation between the first user and the second user. For instance, the first user and the second user follow each other, the second user follows the first user, or the first user follows the second user, etc.

According to different association relations, the first user and the second user may carry out different interactions with each other. For instance, in a case that the first user and the second user follow each other, the first user and the second user may make voice/video calls, carry out sharing and interactive watching, send private messages, etc. with each other. In a case that the second user unilaterally follows the first user, the first user and the second user may carry out sharing and interactive watching, send private messages, etc. with each other.

Alternatively, on the basis of Embodiment 1, the method further includes: after step 101, displaying a prompt interface on the media content playing interface in response to detecting that the second user does not trigger the interaction identifier to carry out an interaction, where the prompt interface is configured to prompt the second user to trigger the interaction identifier to carry out an interaction.

In this embodiment, in a case that the second user does not use the interaction identifier to implement an interaction with the first user, the second user may not know how to use the interaction identifier. In this case, a prompt interface may be displayed within the media content playing interface, and a method for using the interaction identifier may be displayed on the prompt interface such that the second user triggers the interaction identifier to carry out an interaction with the first user.

According to the interaction method provided in this embodiment, the interaction identifier associated with the online state of the first user associated with the currently played media content is displayed within the media content playing interface, and the interface for carrying out interaction with the first user, which is associated with the online state, is presented according to the triggering for the interaction identifier such that the second user can implement the interaction by triggering the interaction identifier on the media content playing interface, the operation is simple.

Further, on the basis of Embodiment 1, after step 101, the method further includes: configuring the interaction identifier associated with the online state of the first user associated with the currently played media content as a first interaction identifier upon determining that the online state of the first user is the first state, wherein the first interaction identifier is configured to carry out a preset real-time interaction with the first user; and/or configuring the interaction identifier associated with the online state of the first user associated with the currently played media content as a second interaction identifier upon determining that the online state of the first user is the second state, wherein the second interaction identifier is configured to carry out a preset non-real-time interaction with the first user.

In this embodiment, the second user may carry out different interactions with the first user in response to different online states. Specifically, upon determining that the online state of the first user is the first state, the first interaction identifier of the first user associated with the currently played media content may be displayed within the media content playing interface, and the second user may carry out a preset real-time interaction with the first user by triggering the first interaction identifier. The preset real-time interaction includes a calling or a shared interaction for watching. The calling includes a video calling or a voice calling. The shared interaction for watching refers to that a plurality of users share and play the same video when having a chat (including a voice chat and/or a text chat) such that the plurality of users can watch the same video when having a chat.

For instance, upon determining that the first user is currently online, the second user may carry out a video calling with the first user in response to a triggering by the second user for the first interaction identifier.

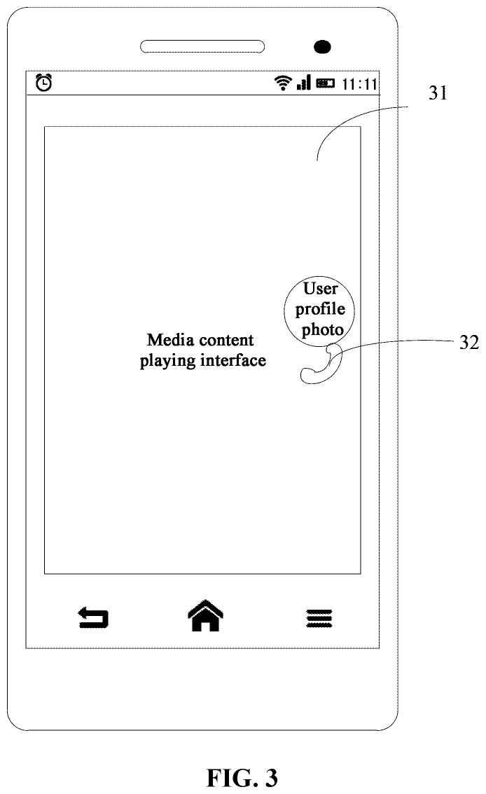

FIG. 3 is a schematic diagram of a display interface according to an embodiment of this disclosure. As shown in FIG. 3, upon determining that the online state of the first user is the first state, a first interaction identifier 32 associated with the online state of the first user may be displayed within the media content playing interface 31, and the first interaction identifier 32 may be a small phone icon.

Alternatively, upon determining that a current online state of the first user is the second state, a second interaction identifier of the first user associated with currently played media content may be displayed within the media content playing interface, and a second user may carry out a preset non-real-time interaction with the first user by triggering the second interaction identifier. The preset non-real-time interaction includes, but is not limited to, sending a private message to the first user, sending information to other social software associated with the first user, etc.

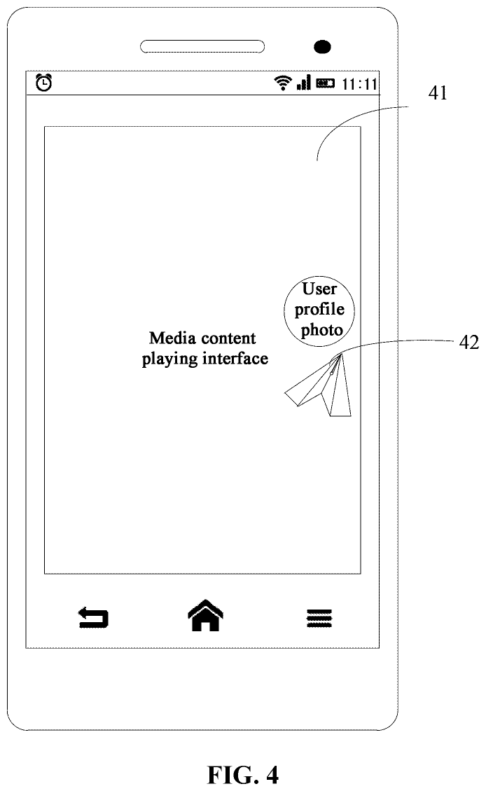

FIG. 4 is a schematic diagram of another display interface according to an embodiment of this disclosure. As shown in FIG. 4, upon determining that the online state of the first user is the second state, a second interaction identifier 42 associated with the online state of the first user may be displayed within the media content playing interface 41, and the second interaction identifier 42 may be a small airplane icon.

According to the interaction method provided in the embodiment, interaction identifiers corresponding to different online states of the first user are displayed such that interactions with the first user can be implemented in different scenarios.

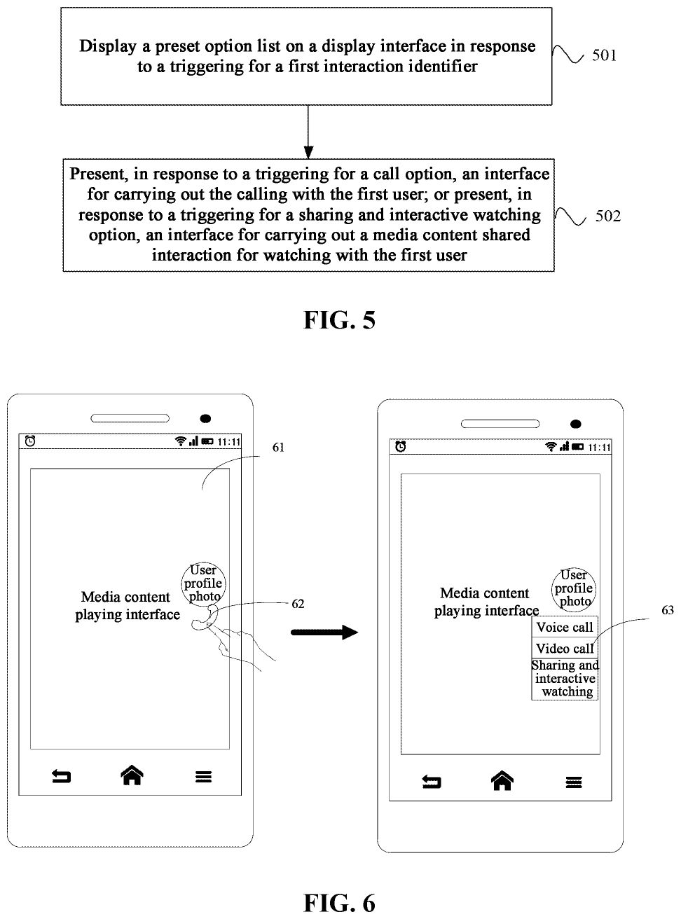

FIG. 5 is a schematic flow diagram of an interaction method according to Embodiment 2 of this disclosure. On the basis of Embodiment 1, step 102 includes the following:

Step 501: a preset option list is displayed on a display interface in response to a triggering for the first interaction identifier, where the option list includes a call option and/or a sharing and interactive watching option.

Step 502: in response to a triggering for a call option, an interface for carrying out the calling with the first user is presented; or in response to a triggering for a sharing and interactive watching option, an interface for carrying out a media content shared interaction with the first user is presented.

In this embodiment, the preset real-time interaction includes a calling or a shared interaction for watching. During actual application, the second user may select different interaction modes according to actual requirements, so as to carry out interactions with the first user. For example, a preset option list may be displayed on the media content playing interface in response to a triggering by the second user for the first interaction identifier. The option list includes a call option and/or a sharing and interactive watching option. The second user may select, according to actual requirements, interactions required to be carried out in the option list.

Upon determining that the second user selects the call option, an interface for carrying out the calling with the first user may be displayed on the media content playing interface or a display interface in response to a triggering by the second user for the call option. Upon determining that the second user selects the sharing and interactive watching option, an interface for carrying out a media content shared interaction with the first user is displayed in response to a triggering by the second user for the sharing and interactive watching option. During the media content shared interaction, the first user and the second user can simultaneously watch the same media content and keep connected.

FIG. 6 is a schematic diagram of an interaction interface according to an embodiment of this disclosure. As shown in FIG. 6, a first interaction identifier 62 may be displayed on a media content playing interface 61. The second user may carry out a triggering on the first interaction identifier 62. A preset option list 63 may be displayed on a display interface in response to the triggering. The option list 63 includes a call option and/or a sharing and interactive watching option.

According to the interaction method provided in this embodiment, the preset option list is displayed on the media content playing interface according to the triggering for the first interaction identifier such that the second user may select, according to actual requirements, corresponding interaction modes to carry out interactions, the interactions can better satisfy the requirements of the second user.

Further, on the basis of any one of the above embodiments, the step of presenting an interface for carrying out the calling with the first user in step 502 includes: displaying, according to a call type corresponding to the calling, a real-time interaction identifier corresponding to the call type on the media content playing interface, where the call type includes a voice call type and a video call type; or skipping, according to a call type corresponding to the calling, from the media content playing interface to a call detail interface corresponding to the call type.

In this embodiment, in order not to affect browsing of the media content by the user during the calling, a current real-time interaction identifier may be displayed on the media content playing interface. In response to different call types, real-time interaction identifiers corresponding to the call types may be displayed on the media content playing interface. The call types include a voice call type and a video call type. For instance, in response to a voice call type, a profile photo of the first user may be displayed on the media content playing interface to serve as a real-time interaction identifier.

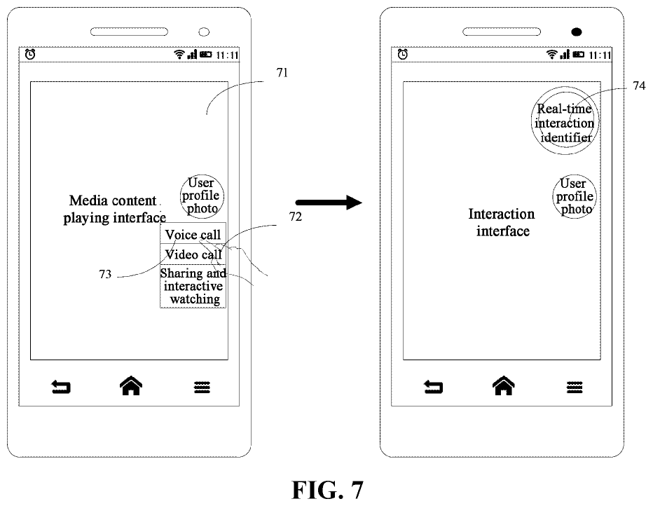

FIG. 7 is a schematic diagram of another interaction interface according to an embodiment of this disclosure. As shown in FIG. 7, a user may carry out a triggering on a call option 73 in an option list 72 displayed on a media content playing interface 71, and a real-time interaction identifier 74 corresponding to a call type may be displayed on the display interface in response to the triggering. In this embodiment, the call type may be a voice call type. In this case, the real-time interaction identifier 74 may be a user profile photo of the first user.

Alternatively, during the calling, a current display interface may skip, directly according to a call type corresponding to the calling, from the media content playing interface to a call detail interface corresponding to the call type.

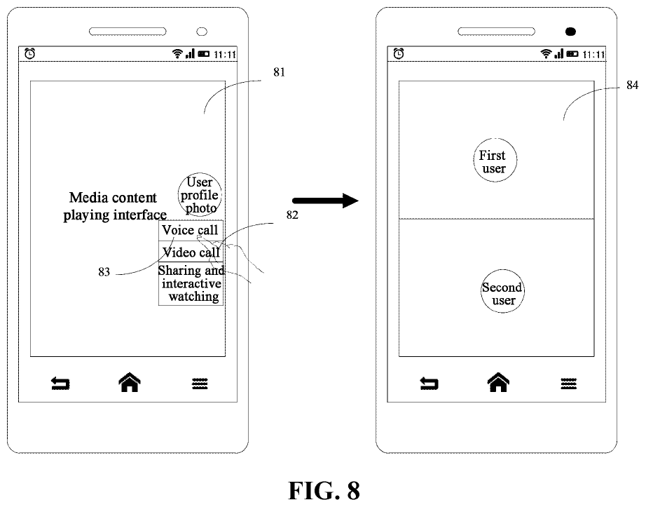

FIG. 8 is a schematic diagram of another interaction interface according to an embodiment of this disclosure. As shown in FIG. 8, a user may carry out a triggering on a call option 83 in an option list 82 displayed on a media content playing interface 81, and the display interface may skip, in response to the triggering, to display a call detail interface 84 for the calling.

Alternatively, upon determining that the current call type is a video call type, the second user may change the call type by adjusting a size of the call detail interface. For example, a current call type is switched to a voice call type in response to a size reduction operation by the second user for the call detail interface, and a real-time interaction identifier corresponding to the voice call is displayed on the media content playing interface.

Further, on the basis of any one of the above embodiments, presenting, in response to a triggering for the sharing and interactive watching option, the interface for carrying out the media content shared interaction with the first user includes: displaying, on the media content playing interface, a real-time interaction identifier during media content sharing and interacting.

In this embodiment, in order to enable the user to timely understand a current interaction, after the second user triggers the sharing and interactive watching option, a real-time interaction identifier during a media content sharing and interacting may be displayed on the media content playing interface.

Therefore, the interaction with the first user can be rapidly implemented, and the second user can know a current interaction in time.

Further, on the basis of any one of the above embodiments, the method further includes: acquiring, in response to a moving for the real-time interaction identifier, a moving speed and/or a moving distance corresponding to the moving and/or a target position of the real-time interaction identifier when the moving is stopped; and displaying an interaction ending icon on the media content playing interface in response to the detected moving speed exceeding a preset speed threshold, and/or the moving distance exceeding a preset distance threshold, and/or the target position being in a preset interaction ending area.

In this embodiment, after the interaction identifier corresponding to the call type or the real-time interaction identifier during a media content sharing and interacting is displayed, the user may move the real-time interaction identifier or end the call by dragging the real-time interaction identifier.

Alternatively, after the moving by the user for the real-time interaction identifier is acquired, a moving speed and/or a moving distance corresponding to the moving and/or a target position of the real-time interaction identifier when the moving is stopped may be acquired. An interaction ending icon is displayed on the media content playing interface in response to determining that it is detected that the moving speed exceeds a preset speed threshold, and/or the moving distance exceeds a preset distance threshold, and/or the target position is in a preset interaction ending area.

Further, on the basis of any one of the above embodiments, the method further includes: after displaying the interaction ending icon on the media content playing interface, ending a current real-time interaction in response to determining that it is detected that the real-time interaction identifier moves to a preset area associated with the interaction ending icon; or ending a current real-time interaction in response to a triggering for the interaction ending icon.

In this embodiment, after the interaction ending icon is displayed on the media content playing interface, the user may implement an ending for a current interaction by dragging the real-time interaction identifier to a preset area associated with the interaction ending icon, or may implement an ending for a current interaction by triggering the interaction ending icon.

For example, in response to the moving by the user for the real-time interaction identifier, a current real-time interaction is ended in response to determining that it is detected that the real-time interaction identifier moves to a preset area associated with the interaction ending icon; or a current real-time interaction is ended in response to determining that the triggering by the user for an activity ending icon is detected.

According to the interaction method provided in this embodiment, in response to determining that it is detected that the moving speed exceeds a preset speed threshold, and/or the moving distance exceeds a preset distance threshold, and/or the target position is in a preset interaction ending area, the interaction ending icon is displayed on the media content playing interface such that the user can rapidly implement the ending for the current interaction according to the interaction ending icon, the operation is convenient.

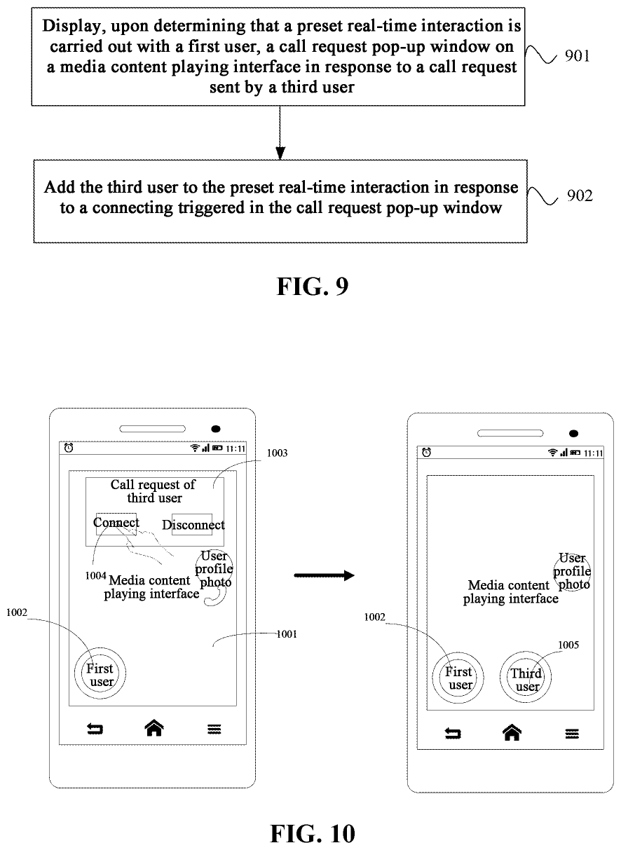

FIG. 9 is a schematic flow diagram of an interaction method according to Embodiment 3 of this disclosure. As shown in FIG. 9, the method further includes the following:

Step 901: upon determining that preset real-time interaction is carried out with a first user, a call request pop-up window on a media content playing interface is displayed in response to a call request sent by a third user.

Step 902: the third user to the preset real-time interaction is added in response to a connecting triggered in the call request pop-up window.

In this embodiment, when the second user carries out a real-time interaction with the first user, and a call request triggered by a third user is received, the third user can be rapidly added to the current real-time interaction. For example, when the second user carries out a preset real-time interaction with the first user, whether a call request sent by another third user is received may be monitored. In a case that the call request is acquired, a call request pop-up window may be displayed on the media content playing interface. The call request pop-up window may include an identifier of the third user, a connecting icon, an interaction ending icon, etc. In a case that a triggering by the first user or the second user for a connecting icon is acquired, the third user may be added to the preset real-time interaction in response to the connecting triggered within the call request pop-up window.

FIG. 10 is a schematic diagram of another interaction interface according to an embodiment of this disclosure. As shown in FIG. 10, a real-time interaction identifier 1002 corresponding to the second user may be displayed on the media content playing interface 1001 when a preset real-time interaction is carried out on the first user, and a call request pop-up window 1003 may be displayed on the media content playing interface 1001 in response to a call request sent by the third user. In a case that it is detected that the second user triggers a preset connecting icon 1004 within the call request pop-up window 1003 to trigger a connecting, the third user may be connected to the current real-time interaction, and a real-time interaction identifier 1005 corresponding to the third user may be displayed on the media content playing interface 1001.

Alternatively, after the call request pop-up window is displayed, a calling may be carried out directly with the third user in a case that the triggering by the second user for the call request pop-up window is not acquired after a preset time period.

According to the interaction method provided in this embodiment, the third user is added to the current interaction in response to the call request sent by the third user such that multi-user interactions can be rapidly implemented, and the operations are simple.

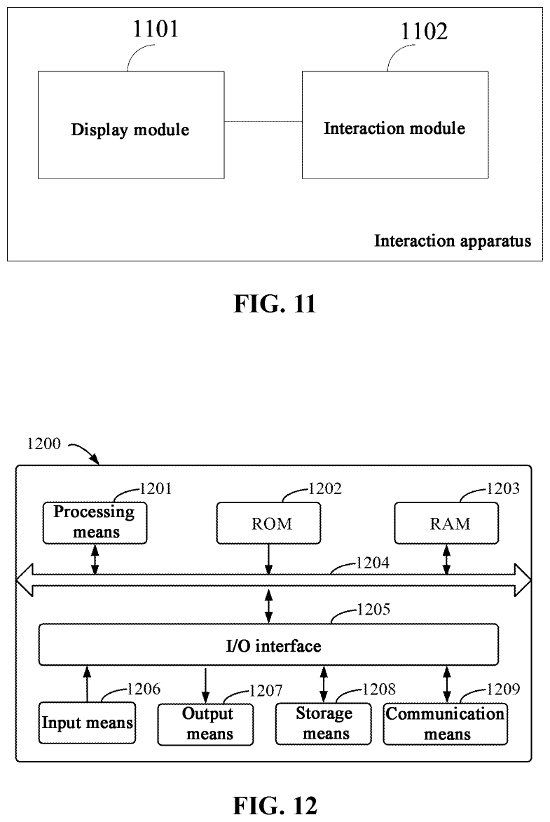

FIG. 11 is a schematic structural diagram of an interaction apparatus provided in Embodiment 4 of this disclosure. The interaction apparatus is applied at a second user side, and as shown in FIG. 11, the interaction apparatus includes a display module 1101 and an interaction module 1102. The display module 1101 is configured to display, within a preset display area on a media content playing interface, an interaction identifier associated with an online state of a first user associated with currently played media content. The interaction module 1102 is configured to present, in response to a triggering for the interaction identifier associated with the online state, an interface for carrying out interaction with the first user, which is associated with the online state.

Further, on the basis of Embodiment 1, the online state of the first user includes a first state and a second state. The first state includes a state of being currently online, and the second state includes a state of being currently offline; or the first state includes a state of being online in a preset time period, and the second state includes a state of being offline in the preset time period. Further, on the basis of any one of the above embodiments, the display module is configured to configure the interaction identifier associated with the online state of the first user associated with the currently played media content as a first interaction identifier upon determining that the online state of the first user is the first state, where the first interaction identifier is configured to carry out a preset real-time interaction with the first user; and/or configure the interaction identifier associated with the online state of the first user associated with the currently played media content as a second interaction identifier upon determining that the online state of the first user is the second state, where the second interaction identifier is configured to carry out a preset non-real-time interaction with the first user.

Further, on the basis of any one of the above embodiments, the first user satisfies a preset relation with a second user.

Further, on the basis of any one of the above embodiments, the first user associated with the currently played media content is a poster of the currently played media content.

Further, on the basis of any one of the above embodiments, the preset real-time interaction includes a calling or a shared interaction for watching.

Further, on the basis of any one of the above embodiments, the interaction module is configured to display a preset option list on a display interface in response to a triggering for the first interaction identifier, where the option list includes a call option and/or a sharing and interactive watching option; and present, in response to a triggering for the call option, an interface for carrying out the calling with the first user; or present, in response to a triggering for the sharing and interactive watching option, an interface for carrying out a media content shared interaction with the first user.

Further, on the basis of any one of the above embodiments, the interaction module is configured to display, according to a call type corresponding to the calling, a real-time interaction identifier corresponding to the call type on the media content playing interface, where the call type includes a voice call type and a video call type; or skip, according to a call type corresponding to the calling, from the media content playing interface to a call detail interface corresponding to the call type.

Further, on the basis of any one of the above embodiments, the interaction module is configured to display, on the media content playing interface, a real-time interaction identifier during media content sharing and interacting.

Further, on the basis of any one of the above embodiments, the apparatus further includes: a movement module, which is configured to acquire, in response to a moving for the real-time interaction identifier, a moving speed and/or a moving distance corresponding to the moving and/or a target position of the real-time interaction identifier when the moving is stopped; and a processing module, which is configured to display an interaction ending icon on the media content playing interface in response to determining that it is detected that the moving speed exceeds a preset speed threshold, and/or the moving distance exceeds a preset distance threshold, and/or the target position is in a preset interaction ending area

Further, on the basis of any one of the above embodiments, the apparatus further includes an ending module, which is configured to end a current real-time interaction in response to determining that it is detected that the real-time interaction identifier moves to a preset area associated with the interaction ending icon; or further configured to end the current real-time interaction in response to a triggering for the interaction ending icon.

Further, on the basis of any one of the above embodiments, the apparatus further includes: a request module, which is configured to display, upon determining that the preset real-time interaction is carried out with the first user, a call request pop-up window on the media content playing interface in response to a call request sent by a third user; and an interaction module, which is configured to add the third user to the preset real-time interaction in response to a connecting triggered in the call request pop-up window.

Another embodiment of this disclosure further provides an electronic device. The electronic device includes a processor and a memory; the memory storing computer-executable instructions; and the processor, when executing the computer-executable instructions stored in the memory, configured to perform the interaction method described in any one of the above embodiments.

Another embodiment of this disclosure further provides a computer-readable storage medium, storing computer-executable instructions, a processor, when executing the computer-executable instructions, configured to implement the interaction method described in any one of the above embodiments when executing the computer-executable instruction.

Another embodiment of this disclosure further provides a computer program product. The computer program product includes a computer program, where the computer program, when executed by a processor, implements the interaction method described in any one of the above embodiments.

Another embodiment of this disclosure provides a computer program. The computer program, when executed by a processor, implements the interaction method described in any one of the above embodiments.

An interaction method and apparatus, a device, a computer-readable storage medium, a program product and a program are provided in this embodiment. According to the method, the interaction identifier associated with the online state of the first user associated with the currently played media content is displayed on the media content playing interface, and the interface for carrying out interaction with the first user, which is associated with the online state, is presented according to the triggering for the interaction identifier such that the second user can implement the interaction by triggering the interaction identifier on the media content playing interface, the operation is simple.

The device provided in this embodiment can be configured to execute the technical solution of the above method embodiment, and has similar implementation principles and technical effects, which will not be repeated in this embodiment.

In order to implement the above embodiments, an embodiment of this disclosure further provides an electronic device.

FIG. 12 is a schematic structural diagram of an electronic device according to Embodiment 5 of this disclosure. As shown in FIG. 12, a schematic structural diagram of an electronic device 1200 suitable for being configured to implement the embodiment of this disclosure is shown. The electronic device 1200 may be a terminal device or a server. The terminal device may include, but is not limited to, a mobile terminal such as a mobile phone, a notebook computer, a digital broadcast receiver, a personal digital assistant (PDA), a portable android device (PAD), a portable media player (PMP) and an in-vehicle terminal (such as an in-vehicle navigation terminal), and a stationary terminal such as a digital television (TV) and a desktop computer. The electronic device shown in FIG. 12 is merely an instance, and should not bring any limitation on functions and use scopes of the embodiments of this disclosure.

As shown in FIG. 12, the electronic device 1200 may include a processing means (such as a central processing unit and a graphics processor) 1201 that may execute various appropriate actions and processing according to programs stored in a read only memory (ROM) 1202 or loaded into a random access memory (RAM) 1203 from a storage means 1208. In the RAM 1203, various programs and data required for operations of the electronic device 1200 are further stored. The processing means 1201, the ROM 1202 and the RAM 1203 are connected to each other by means of a bus 1204. An input/output (I/O) interface 1205 is further connected to bus 1204.

Generally, the following means may be connected to the I/O interface 1205: an input means 1206 including a touch screen, a touch pad, a keyboard, a mouse, a camera, a microphone, an accelerometer, a gyroscope, etc.; an output means 1207 including a liquid crystal display (LCD), a speaker, a vibrator, etc.; a storage means 1208 including a magnetic tape and a hard disk; and a communication means 1209. The communication means 1209 may allow the electronic device 1200 to be in wireless or wired communication with other devices for data exchange. Although FIG. 12 shows an electronic device 1200 having various means, it should be understood that not all of the shown means are required to be implemented or provided. More or fewer means may be alternatively implemented or provided.

In particular, according to an embodiment of this disclosure, the process described above with reference to a flow diagram may be implemented as a computer software program. For instance, an embodiment of this disclosure includes a computer program product. The computer program product includes a computer program carried on a computer-readable medium, and the computer program includes a program code for executing the method shown in the flow diagram. In such an embodiment, the computer program may be downloaded from a network by means of a communication means 1209 and mounted, or mounted from a storage means 1208, or mounted from the ROM 1202. When executed by the processing means 1201, the computer program executes the above functions defined in a method in an embodiment of this disclosure.

It should be noted that the above computer-readable medium in this disclosure may be a computer-readable signal medium, a computer-readable storage medium, or any combination thereof. The computer-readable storage medium may include, but is not limited to, electronic, magnetic, optical, electromagnetic, infrared or semiconductor systems, apparatuses or devices, or any combination of the foregoing. More particular instances of the computer-readable storage medium may include, but is not limited to, an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the forgoing. In this disclosure, a computer-readable storage medium may be any tangible medium that may include, or store a program that may be used by or in connection with an instruction execution system, apparatus or device. In this disclosure, a computer-readable signal medium may include a data signal propagated in a baseband or as part of a carrier wave, and a computer-readable program code is carried in the data signal. Such a propagated data signal may employ a plurality of forms, which include, but are not limited to, an electromagnetic signal, an optical signal or any suitable combination of the foregoing. The computer-readable signal medium may also be any computer-readable medium rather than a computer-readable storage medium, and may send, propagate or transmit a program that is used by or in combination with an instruction execution system, apparatus or device. The program code included in the computer-readable medium may be transmitted by means of any appropriate media, which include, but are not limited to, a wire, an optical fiber cable, a radio frequency (RF), etc., or any suitable combination of the foregoing.

The above computer-readable medium may be included in the above electronic device, and may exist independently without being assembled into the electronic device.

The above computer-readable medium carries one or more programs, and when the one or more programs are executed by the electronic device, the electronic device executes the method shown in the above embodiment.

The computer program code for executing an operation of this disclosure may be written in one or more programming languages or a combination thereof. The above programming languages include object oriented programming languages such as Java, Smalltalk and C++, and conventional procedural programming languages such as a “C” language or similar programming languages. The program code may be executed entirely on a user computer, executed partially on the user computer, executed as a stand-alone software package, executed partially on the user computer and partially on a remote computer, or executed entirely on the remote computer or a server. In a case that the remote computer is involved, the remote computer may be connected to the user computer by means of any type of network, which includes a local area network (LAN) or a wide area network (WAN), or may be connected to an external computer (for embodiment, by means of the internet by an internet service provider).

Flow diagrams and block diagrams in figures show system architectures, functions and operations, which may be implemented according to systems, methods and computer program products in various embodiments of this disclosure. In this regard, each block in flow diagrams or block diagrams can represent a module, a program segment, or part of a code, which include one or more executable instructions for implementing specified logical functions. It should also be noted that in some substitutive implementations, functions noted in blocks can also occur in sequences different from those in figures. For instance, functions represented by two continuous blocks can be executed substantially in parallel in practice, and sometimes implemented in reverse sequences, which depends on the involved functions. It should also be noted that each block in flow diagrams and/or block diagrams, and combinations of the blocks in the flow diagrams and/or the block diagrams, can be implemented by means of dedicated hardware-based systems that execute specified functions or operations, or can be implemented by means of combinations of dedicated hardware and computer instructions.

Units described in embodiments of this disclosure can be implemented in a form of software or hardware. In some cases, a name of a unit does not constitute a limitation on the unit itself. For instance, the first acquisition unit may also be described as “a unit acquiring at least two internet protocol addresses”.

At least part of the functions described above herein can be executed by one or more hardware logic components. For instance, without limitation, exemplary types of hardware logic components that may be used include a field programmable gate array (FPGA), an application specific integrated circuit (ASIC), an application specific standard product (ASSP), system on chip (SOC), a complex programmable logic device (CPLD), etc.

In a context of this disclosure, a machine-readable medium may be a tangible medium, which may include or store a program for being used by or in connection with an instruction execution system, apparatus or device. The machine-readable medium may be a machine-readable signal medium or a machine-readable storage medium. The machine-readable medium may include, but is not limited to, electronic, magnetic, optical, electromagnetic, infrared or semiconductor systems, apparatuses or devices, or any suitable combination of the foregoing. More specific embodiments of the machine-readable storage medium may include an electrical connection based on one or more wires, a portable computer disk, a hard disk, a random-access memory (RAM), a read-only memory (ROM), an erasable programmable read-only memory (EPROM or a flash memory), an optical fiber, a compact disk read-only memory (CD-ROM), an optical storage device, a magnetic storage device or any suitable combination of the foregoing.

In a first aspect, according to one or more embodiments of this disclosure, an interaction method is provided. The interaction method is applied at a second user side and includes: displaying, within a preset display area on a media content playing interface, an interaction identifier associated with an online state of a first user associated with currently played media content; and presenting, in response to a triggering for the interaction identifier associated with the online state, an interface for carrying out interaction with the first user, which is associated with the online state.

According to one or more embodiments of this disclosure, the online state of the first user includes a first state and a second state.

The first state includes a state of being currently online and the second state includes a state of being currently offline; or the first state includes a state of being online in a preset time period, and the second state includes a state of being offline in the preset time period.

According to one or more embodiments of this disclosure, displaying the interaction identifier associated with the online state of the first user associated with the currently played media content includes: configuring the interaction identifier associated with the online state of the first user associated with the currently played media content as a first interaction identifier upon determining that the online state of the first user is the first state, where the first interaction identifier is configured to carry out a preset real-time interaction with the first user; and/or configuring the interaction identifier associated with the online state of the first user associated with the currently played media content as a second interaction identifier upon determining that the online state of the first user is the second state, where the second interaction identifier is configured to carry out a preset non-real-time interaction with the first user.

According to one or more embodiments of this disclosure, the first user satisfies a preset relation with a second user.

According to one or more embodiments of this disclosure, the first user associated with the currently played media content is a poster of the currently played media content.

According to one or more embodiments of this disclosure, the preset real-time interaction includes a calling or a shared interaction for watching.

According to one or more embodiments of this disclosure, presenting, in response to the triggering for the interaction identifier associated with the online state, the interface for carrying out interaction with the first user, which is associated with the online state, includes: displaying a preset option list on a display interface in response to a triggering for the first interaction identifier, where the option list includes a call option and/or a sharing and interactive watching option; and presenting, in response to a triggering for the call option, an interface for carrying out the calling with the first user; or presenting, in response to a triggering for the sharing and interactive watching option, an interface for carrying out a media content shared interaction with the first user.

According to one or more embodiments of this disclosure, presenting the interface for carrying out the calling with the first user includes: displaying, according to a call type corresponding to the calling, a real-time interaction identifier corresponding to the call type on the media content playing interface, where the call type includes a voice call type and a video call type; or skipping, according to a call type corresponding to the calling, from the media content playing interface to a call detail interface corresponding to the call type.

According to one or more embodiments of this disclosure, presenting, in response to a triggering for the sharing and interactive watching option, the interface for carrying out the media content shared interaction with the first user includes: displaying, on the media content playing interface, a real-time interaction identifier during media content sharing and interacting.

According to one or more embodiments of this disclosure, the method further includes: acquiring, in response to a moving for the real-time interaction identifier, a moving speed and/or a moving distance corresponding to the moving and/or a target position of the real-time interaction identifier when the moving is stopped; and displaying an interaction ending icon on the media content playing interface in response to determining that it is detected that the moving speed exceeds a preset speed threshold, and/or the moving distance exceeds a preset distance threshold, and/or the target position is in a preset interaction ending area.

According to one or more embodiments of this disclosure, the method further includes: after displaying the interaction ending icon on the media content playing interface, ending a current real-time interaction in response to determining that it is detected that the real-time interaction identifier moves to a preset area associated with the interaction ending icon; or ending a current real-time interaction in response to a triggering for the interaction ending icon.

According to one or more embodiments of this disclosure, the method further includes: displaying, upon determining that the preset real-time interaction is carried out with the first user, a call request pop-up window on the media content playing interface in response to a call request sent by a third user; and adding the third user to the preset real-time interaction in response to a connecting triggered in the call request pop-up window.

In a second aspect, according to one or more embodiments of this disclosure, an interaction apparatus is provided. The interaction apparatus includes: a display module, which is configured to display, within a preset display area on a media content playing interface, an interaction identifier associated with an online state of a first user associated with currently played media content; and an interaction module, which is configured to present, in response to a triggering for the interaction identifier associated with the online state, an interface for carrying out interaction with the first user, which is associated with the online state.

According to one or more embodiments of this disclosure, the online state of the first user includes a first state and a second state. The first state includes a state of being currently online, and the second state includes a state of being currently offline; or the first state includes a state of being online in a preset time period, and the second state includes a state of being offline in the preset time period.

According to one or more embodiments of this disclosure, the display module is configured to configure the interaction identifier associated with the online state of the first user associated with the currently played media content as a first interaction identifier upon determining that the online state of the first user is the first state, where the first interaction identifier is configured to carry out a preset real-time interaction with the first user; and/or configure the interaction identifier associated with the online state of the first user associated with the currently played media content as a second interaction identifier upon determining that the online state of the first user is the second state, where the second interaction identifier is configured to carry out a preset non-real-time interaction with the first user.

According to one or more embodiments of this disclosure, the first user satisfies a preset relation with a second user. According to one or more embodiments of this disclosure, the first user associated with the currently played media content is a poster of the currently played media content.

According to one or more embodiments of this disclosure, the preset real-time interaction includes a calling or a shared interaction for watching.

According to one or more embodiments of this disclosure, the interaction module is configured to display a preset option list on a display interface in response to a triggering for the first interaction identifier, where the option list includes a call option and/or a sharing and interactive watching option; and present, in response to a triggering for the call option, an interface for carrying out the calling with the first user; or present, in response to a triggering for the sharing and interactive watching option, an interface for carrying out a media content shared interaction with the first user.

According to one or more embodiments of this disclosure, the interaction module is configured to display, according to a call type corresponding to the calling, a real-time interaction identifier corresponding to the call type on the media content playing interface, where the call type includes a voice call type and a video call type; or skip, according to a call type corresponding to the calling, from the media content playing interface to a call detail interface corresponding to the call type.

According to one or more embodiments of this disclosure, the interaction module is configured to display, on the media content playing interface, a real-time interaction identifier during a media content sharing and interacting.

According to one or more embodiments of this disclosure, the apparatus further includes: a movement module, which is configured to acquire, in response to a moving for the real-time interaction identifier, a moving speed and/or a moving distance corresponding to the moving and/or a target position of the real-time interaction identifier when the moving is stopped; and a processing module, which is configured to display an interaction ending icon on the media content playing interface in response to determining that it is detected that the moving speed exceeds a preset speed threshold, and/or the moving distance exceeds a preset distance threshold, and/or the target position is in a preset interaction ending area.

According to one or more embodiments of this disclosure, the apparatus further includes: an ending module, which is configured to end a current real-time interaction in response to determining that it is detected that the real-time interaction identifier moves to a preset area associated with the interaction ending icon; or further configured to end the current real-time interaction in response to a triggering for the interaction ending icon.

According to one or more embodiments of this disclosure, the apparatus further includes: a request module, which is configured to display, upon determining that the preset real-time interaction is carried out with the first user, a call request pop-up window on the media content playing interface in response to a call request sent by a third user; and an interaction module, which is configured to add the third user to the preset real-time interaction in response to a connecting triggered in the call request pop-up window.

In a third aspect, according to one or more embodiments of this disclosure, an electronic device is provided. The electronic device includes: at least one processor and a memory; the memory storing a computer-executable instruction; and the processor, when executing the computer-executable instructions stored in the memory, configured to perform the interaction method described in the first aspect and all possible designs of the first aspect.

In a fourth aspect, according to one or more embodiments of this disclosure, a computer-readable storage medium is provided. The computer-readable storage medium stores computer-executable instructions, a processor, when executing the computer-executable instructions, configured to implement the interaction method described in the first aspect and all possible designs of the first aspect.

In a fifth aspect, according to one or more embodiments of this disclosure, a computer program product is provided. The computer program product includes a computer program, where the computer program, when executed by a processor, implements the interaction method described in the first aspect and all possible designs of the first aspect.

The above description is only illustrative of preferred embodiments of this disclosure and employed technical principles. Those skilled in the art should understand that the scope involved in this disclosure is not limited to technical solutions formed by a specific combination of the above technical features, and should also cover other technical solutions formed by any combination of the above technical features or their equivalent features without departing from the inventive concept, such as technical solutions formed by interchanging the above features and (non-limitative) technical features having similar functions as disclosed in this disclosure.

Moreover, although various operations are depicted in a specific order, it should not be understood that these operations are required to be executed in a shown specific order or in a sequential order. In certain circumstances, multitasking and parallel processing may be advantageous. Similarly, although several specific implementation details are included in the above discussion, these details should not be construed as limitations on the scope of this disclosure. Some features described in contexts of separate embodiments can also be implemented in a single embodiment in combination. Conversely, various features described in a context of a single embodiment can also be implemented in a plurality of embodiments separately or in any suitable sub-combination.

Although the subject matter is described in language specific to structural features and/or methodological logical actions, it should be understood that the subject matter defined in the appended claims is not necessarily limited to the specific features or actions described above. Conversely, the specific features and actions described above are merely instance forms for implementing the claims.

What is claimed is:

1. An interaction method, applied at a second user side and comprising:
displaying, within a preset display area on a media content playing interface, an interaction identifier associated with an online state of a first user associated with currently played media content; and
presenting, in response to a triggering for the interaction identifier associated with the online state, an interface for carrying out interaction with the first user, which is associated with the online state.

2. The method according to claim 1, wherein the online state of the first user comprises a first state and a second state; and
the first state comprises a state of being currently online, and the second state comprises a state of being currently offline; or
the first state comprises a state of being online in a preset time period, and the second state comprises a state of being offline in the preset time period.

3. The method according to claim 1, wherein displaying the interaction identifier associated with the online state of the first user associated with the currently played media content comprises at least one of:
configuring the interaction identifier associated with the online state of the first user associated with the currently played media content as a first interaction identifier upon determining that the online state of the first user is the first state, wherein the first interaction identifier is configured to carry out a preset real-time interaction with the first user; or
configuring the interaction identifier associated with the online state of the first user associated with the currently played media content as a second interaction identifier upon determining that the online state of the first user is the second state, wherein the second interaction identifier is configured to carry out a preset non-real-time interaction with the first user.

4. The method according to claim 1, wherein the first user satisfies a preset relation with a second user.

5. The method according to claim 1, wherein the first user associated with the currently played media content is a poster of the currently played media content.

6. The method according to claim 3, wherein the preset real-time interaction comprises a calling or a shared interaction for watching.

7. The method according to claim 6, wherein presenting, in response to the triggering for the interaction identifier associated with the online state, the interface for carrying out interaction with the first user, which is associated with the online state, comprises:
displaying a preset option list on a display interface in response to a triggering for the first interaction identifier, wherein the option list comprises at least one of a call option or a sharing and interactive watching option; and
presenting, in response to a triggering for the call option, an interface for carrying out the calling with the first user; or presenting, in response to a triggering for the sharing and interactive watching option, an interface for carrying out a media content shared interaction with the first user.

8. The method according to claim 7, wherein presenting the interface for carrying out the calling with the first user comprises:
displaying, according to a call type corresponding to the calling, a real-time interaction identifier corresponding to the call type on the media content playing interface, wherein the call type comprises a voice call type and a video call type; or
skipping, according to a call type corresponding to the calling, from the media content playing interface to a call detail interface corresponding to the call type.

9. The method according to claim 7, wherein presenting, in response to a triggering for the sharing and interactive watching option, the interface for carrying out the media content shared interaction with the first user comprises:
displaying, on the media content playing interface, a real-time interaction identifier during media content sharing and interacting.

10. The method according to claim 8, further comprising:
acquiring, in response to a moving for the real-time interaction identifier, a moving speed and/or a moving distance corresponding to the moving and/or a target position of the real-time interaction identifier when the moving is stopped; and
displaying an interaction ending icon on the media content playing interface in response to determining that it is detected that the moving speed exceeds a preset speed threshold, and/or the moving distance exceeds a preset distance threshold, and/or the target position is in a preset interaction ending area.

11. The method according to claim 10, further comprising: after displaying the interaction ending icon on the media content playing interface, ending a current real-time interaction in response to determining that it is detected that the real-time interaction identifier moves to a preset area associated with the interaction ending icon; or
ending a current real-time interaction in response to a triggering for the interaction ending icon.

12. The method according to claim 3, further comprising:
displaying, upon determining that the preset real-time interaction is carried out with the first user, a call request pop-up window on the media content playing interface in response to a call request sent by a third user; and
adding the third user to the preset real-time interaction in response to a connecting triggered in the call request pop-up window.

13. (canceled)

14. An electronic device, comprising: a processor and a memory;
the memory storing computer-executable instructions; and
the processor, when executing the computer-executable instructions stored in the memory, configured to:
display, within a preset display area on a media content playing interface, an interaction identifier associated with an online state of a first user associated with currently played media content; and
present, in response to a triggering for the interaction identifier associated with the online state, an interface for carrying out interaction with the first user, which is associated with the online state.

15. A computer-readable storage medium, storing computer-executable instructions, a processor, when executing the computer-executable instructions, configured to:
display, within a preset display area on a media content playing interface, an interaction identifier associated with an online state of a first user associated with currently played media content; and
present, in response to a triggering for the interaction identifier associated with the online state, an interface for carrying out interaction with the first user, which is associated with the online state.

16. (canceled)

17. (canceled)

18. The electronic device according to claim 14, wherein the online state of the first user comprises a first state and a second state; and
the first state comprises a state of being currently online, and the second state comprises a state of being currently offline; or
the first state comprises a state of being online in a preset time period, and the second state comprises a state of being offline in the preset time period.

19. The electronic device according to claim 14, wherein the processor is configured to display the interaction identifier associated with the online state of the first user associated with the currently played media content by being configured to at least one of:
configuring the interaction identifier associated with the online state of the first user associated with the currently played media content as a first interaction identifier upon determining that the online state of the first user is the first state, wherein the first interaction identifier is configured to carry out a preset real-time interaction with the first user; or
configuring the interaction identifier associated with the online state of the first user associated with the currently played media content as a second interaction identifier upon determining that the online state of the first user is the second state, wherein the second interaction identifier is configured to carry out a preset non-real-time interaction with the first user.

20. The electronic device according to claim 14, wherein the first user satisfies a preset relation with a second user.

21. The electronic device according to claim 14, wherein the first user associated with the currently played media content is a poster of the currently played media content.

22. The electronic device according to claim 19, wherein the preset real-time interaction comprises a calling or a shared interaction for watching.

23. The electronic device according to claim 22, wherein the processor is configured to present, in response to the triggering for the interaction identifier associated with the online state, the interface for carrying out interaction with the first user, which is associated with the online state, by being configured to:
display a preset option list on a display interface in response to a triggering for the first interaction identifier, wherein the option list comprises at least one of a call option or a sharing and interactive watching option; and
present, in response to a triggering for the call option, an interface for carrying out the calling with the first user, or present, in response to a triggering for the sharing and interactive watching option, an interface for carrying out a media content shared interaction for watching with the first user.
